(19) United States
(12) Patent Application Publication
(10) Pub. No.: US 2013/0196207 A1
(43) Pub. Date: Aug. 1, 2013

(54) THERMALLY CONDUCTIVE PLATE HAVING A NETWORK OF FLOW CHANNELS, METHOD FOR TRANSPORT OF HEAT AND ELECTROCHEMICAL ENERGY STORE

(71) Applicant: Christian Zahn, Dresden (DE)

(72) Inventor: Christian Zahn, Dresden (DE)

(73) Assignee: Li-Tec Battery GmbH, Kamenz (DE)

(21) Appl. No.: 13/814,880

(22) PCT Filed: Jul. 29, 2011
(86) PCT No.: PCT/EP11/03828

§ 371 Date: Apr. 16, 2013

(30) Foreign Application Priority Data
Aug. 12, 2010 (DE) 10 2010 034 082.0

(51) Int. Cl. H01M 10/50; F28D 15/00

(52) U.S. Cl. CPC H01M 10/5077; H01M 10/5016; F28D 15/00
USPC 429/120; 165/104.28

(57) ABSTRACT

In the case of a thermally conductive plate (1) having a network of flow channels (2), at least one inlet (3) and at least one outlet (4) for a fluid, the fluid channels are arranged such that a fluid which flows into the network of flow channels at the at least one inlet (3) can flow through an arrangement of zones (5) of the thermally conductive plate whose temperature is to be controlled, and can then flow out of the network of flow channels at the at least one outlet (4). The flow channels are arranged one above the other in at least two levels. The network of flow channels comprises a tree-like structure of distribution channels (6), which is arranged on at least one first level, which distribution channels (6) guide a fluid to zones (5) of the thermally conductive plate whose temperature is to be controlled, starting from the at least one inlet into the network of flow channels. The network of flow channels furthermore comprises a tree-like structure of collecting channels (7) which is arranged on at least one second level, which collecting channels (7) receive a fluid from the distribution channels in the zones (5) of the thermally conductive plate whose temperature is to be controlled and pass out of the network of flow channels at the at least one outlet (4).

### DESCRIPTION

The invention concerns a thermally conductive plate, a method for the transport of heat and an electrochemical energy store and in particular the temperature control of such an electrochemical energy store with the help of a thermally conductive plate. Thermally conductive plates are used in different technical application areas for the transport of heat between heat sources and heat sinks, in particular for the temperature control of technical components and in particular for the cooling of electrochemical energy stores, e.g. in electric vehicles.

DE 10 2008 027 293 A1 describes one such apparatus for the cooling of a vehicle battery having a cooling body with channels through which a fluid flows, wherein the electrochemical storage elements make thermal contact with the cooling body and heat from the storage elements is transferred to the fluid.

DE 10 2008 034 868 A1 describes a battery having a battery housing and a thermally conductive plate arranged within it for the temperature control of the battery, wherein a plurality of thermally conductive single cells, connected to one another in series and/or in parallel and thermally conductively connected with the thermally conductive plate, are thus fixed with its pole contacts protruding though said thermally conductive plate.

DE 10 2008 034 869 A1 describes a battery having a plurality of battery cells forming a cell assembly and a cooling plate connected to the battery cells via a thermally conducting element.

The invention is based on the object of avoiding, possibly at least partly, the disadvantages or limits which are connected with these or other known solutions, and of giving a technical teaching for the transport of heat with the help of a thermally conductive plate. This object is solved by means of an apparatus according to one of the apparatus claims and by means of a method according to one of the method claims.

According to the invention, a thermally conductive plate is provided with a network of flow channels having at least one inlet and one outlet for a fluid. The flow channels are arranged in the thermally conductive plate such that a fluid which flows into the network of flow channels at the at least one inlet flows through an arrangement of zones of the thermally conductive plate whose temperature is to be controlled, and then flow out of the network of flow channels at the at least one outlet. The flow channels are arranged one above the other in at least two levels. The network of flow channels comprises a tree-like structure of distribution channels which is arranged on at least one first level, which distribution channels guide a fluid to zones of the thermally conductive plate whose temperature is to be controlled, starting from the at least one inlet into the network of flow channels. The network of flow channels comprises a tree-like structure of collecting channels which is arranged on at least one second level, which collecting channels receive a fluid from the distribution channels in the zones of the thermally conductive plate whose temperature is to be controlled and guide the fluid out of the network of flow channels at the at least one outlet.

According to the invention, a method for the transport of heat is also provided, in which a thermally conductive plate according to the invention is used. Finally an electrochemical energy store according to the invention is also provided, which, with the help of a method according to the invention, is temperature controlled or whose electrical contacts make thermally conductive contact at least partly with at least one thermally conductive plate according to the invention.

In the context of the description of the present invention, a thermally conductive plate is understood to mean a thermally conductive body which, because of its form or material properties and preferably because of its constructive properties, is suited for transporting heat from at least one heat source to at least one heat sink. According to the present invention, one said thermally conductive plate is provided with a network of flow channels. Through the said channels flows a gaseous, liquid, or flowable fluid, whose chemical or physical composition is chosen such that the flow of this fluid through the flow channels promotes the transport of heat from the at least one heat source to the at least one heat sink. The fluid can, for example, be a coolant or refrigerant which, preferably coming from an external cooling or refrigeration circuit, enters the network of flow channels of the thermally conductive plate at an inlet of the thermally conductive plate, flows through said network of flow channels and finally exits the network of flow channels at an outlet and is fed again to the cooling or refrigeration circuit.

The thermally conductive plate according to the invention includes an arrangement of zones to be temperature controlled, which the flow channels pass through such that the fluid flowing through the flow channels flows through, over and under said zones to be temperature controlled. The said zones to be temperature controlled can completely or partly cover the thermally conductive plate. In particular, said arrangement of zones to be temperature controlled can consist of a single zone to be temperature controlled. The zones to be temperature controlled can be arranged on both sides of the thermally conductive plate in different ways.

The flow channels are arranged in the thermally conductive plate in at least two levels, one above the other. Crossings between said levels are also possible here. Said levels lie preferably essentially parallel to the two essentially parallel large external boundary surfaces of the essentially plate-shaped thermally conductive plate. Here the network of flow channels includes a tree-like structure of distribution channels, which tree-like structure is arranged on one first level, which distribution channels guide a fluid to the zones of the thermally conductive plate whose temperature is to be controlled, starting from the at least one inlet into the network of flow channels. A thermally conductive plate according to the invention can contain a plurality of preferably tree-like fluid channel networks through which different fluids with different physical properties, in particular thermal transport properties, can flow.

The fluid flowing through the flow channels can also preferably change its physical state, in particular to transition from the liquid to gas phase, that is, evaporate and in doing so remove heat from its surroundings, or vice versa, that is, change from the gaseous to the liquid phase, i.e. condense, and in this way deliver heat to its surroundings. Preferably said phase changes can take place in different areas of the network of flow channels at the same time. For example a fluid can evaporate in the distribution channels and condense in the collecting channels or, vice versa, condense in the distribution channels and evaporate in the collecting channels, according to which zones are to be cooled or heated. With other embodiments, evaporation can take place in one part of the zones while condensation takes place in another part of the zones.

In this context, a tree-like structure of distribution channels is understood to mean an arrangement of distribution channels which is designed so that it distributes the fluid, wherein said fluid enters the network of flow channels in the at least one inlet, in the network of flow channels in the manner desired by the user so that fluid flows evenly or as a function of the strength of the heat source or sink in its area, through, over and under the individual zones to be temperature controlled. Branching arterial blood vessels of the human or animal blood circulation system can serve as an illustration of such a tree-like structure of distribution channels. Said arterial blood vessels branch out more and more finely and finally pass to a system of capillary blood vessels which distributes the blood evenly or according to the physiological requirements of certain body regions, to finally be collected in vein-like structures of unifying capillaries. In a similar way, the network of distribution channels of the thermally conductive plate according to the invention includes a tree-like structure of collecting channels arranged in at least one second level, which collecting channels receive a fluid from the distribution channels in the zones of the thermally conductive plate whose temperature is to be controlled, and guide said fluid out of the network of flow channels at the at least one outlet. The veins correspond in this illustration to the collecting channels, while the arteries correspond to the distribution channels.

With a suitable design, the tree-like structures are connected in at least two levels, with the advantage that the flow channels can proceed very flexibly according to the respective requirements of the underlying application, whereas in the case of an arrangement on only one level, limitations would result due to the impossibility of flow channels crossing each other.

In a preferred embodiment of the invention, thermal contact surfaces are provided on at least some of the zones to be temperature controlled on at least one side of the thermally conductive plate, which, through its form, arrangement or material properties is directed to establish a thermally conductive contact of the thermally conductive plate with a heat sink or a heat source. In this way, thermal contact surfaces can preferably be suitably formed, in particular polished surfaces on the inside or on the outside of one of the two essentially parallel external wall surfaces of the thermally conductive plate, which surfaces are so formed and arranged that they promote a thermally conducting contact of the thermally conductive plate with corresponding surfaces of the heat sinks or heat sources.

Also a particular material property of said thermal contact surfaces can promote the thermal conduction between the heat sinks or heat sources to be contacted, in particular when the material, of which said thermal contact surfaces consist, is chosen from a group of materials with particularly high thermal conductivity. In one application of the invention it can be advantageous if the material is so chosen, that in cases of high thermal conductivity, the electrical resistance is so high that essentially an electric insulation is achieved. These material properties are then advantageous when dealing with heat sinks or heat sources with an electrically conductive contact of an electrochemical energy store.

In a preferred embodiment, the thermal contact surfaces belong to one of the at least two groups of thermal contact surfaces, which thermal contact surfaces are electrically insulated from one another and from the remaining thermally conductive plate, but are in thermally conducting contact with at least the rest of the thermally conductive plate. Each group of thermal contact surfaces includes, in this way, preferably those thermal contact surfaces which are in contact with electrically conducting contacts of the same electrical polarity and voltage of a device to be temperature controlled, with the help of the thermally conductive plate. In other technical applications the arrangement can be advantageously arranged in more than two groups, in particular when more than two groups of electrically conducting contacts are to be temperature controlled with the help of the thermally conductive plate. Which groups differ in electrical voltages or another electrical property, such as for example electrical signals on said electrical conductors, so that no electrical connection may be brought about between electrical contacts of different classes.

With these and other preferred embodiments of the present invention, which can also be advantageously combined with one another, the thermal contact surfaces, in addition to improving the thermally conductive contact between the thermally conductive plate and the heat sources or sinks which are to be temperature controlled, also serve to ensure the electrical connection of the electrical conductors to one another, as long as they belong to the same group or class. Therefore in the said embodiment, thermal contact surfaces of differing groups are electrically insulated from one another and from the rest of the thermally conductive plate, but thermally connected with at least the rest of the thermally conductive plate and possibly also thermally connected with one another within the same group. Such structures can be realized, for example, by separating the thermal contact surfaces from the rest of the thermally conductive plate through an electrically insulating but thermally conducting thermal film or thermal paste.

In other preferred embodiments of the invention, which can also be combined with the above described features or other embodiments, at least one thermal contact surface stays in thermally conducting contact with a heat sink or a heat source via an electrically insulating thermal film or electrically insulating thermally conductive paste arranged between the at least one thermal contact surface and a heat sink or heat source. Such thermally conductive pastes are obtained for example by finely distributing small thermally conductive solids in an electrically insulating, preferably waxy material. Thermal contact surfaces can however also be constructed from a thermally conductive, electrically insulating, ceramic layer, which, for example, contains compounds such as lithium carbide or aluminium nitrite. Other examples of materials for the creation of thermally conductive films or thermal contact surfaces are electrically insulating elastomers, whose thermally conductive fillers are in the form of aluminium platelets, for example. The aluminium platelets provide for an improved heat conductivity, whereby the material remains electrically insulating at the same time. Small particles of boron nitride or aluminium are suitable filler materials in thermoelastic rubber compounds or plastics. Thermally conductive films can also take the form of polymer films in which graphite fibres are included as the thermally conductive filler.

In a preferred embodiment, structures for the attachment of fasteners to the thermally conductive plate are provided wherein at least one thermal contact surface can be pressed against a heat sink or heat source with the help of said structures. Such structures are preferably designed in the form of drilled holes equipped with threads so that screws or bolts or similar fastening elements having threads that suit the threads of said drilled holes can be screwed into said drilled holes. Other possibilities for realizing said structures are familiar to the specialist and do not need to be shown here in greater detail. It is advantageous in this context when the fastening structures are made from a material with a high thermal conductivity and it is further advantageous in some application cases if these structures are made from an electrically insulating material or are electrically insulated from the surroundings by using surrounding structures of electrically insulating materials.

In other preferred embodiments of the invention, which can also be combined with the aforementioned embodiment examples and with other embodiment examples, the flow channels are at least partly formed from an electrically insulating yet thermally conductive material. In these embodiment examples, the use of electrically conducting fluids is possible, which often have better thermal conductivity properties than electrically insulating fluids.

According to the invention, a method for the transport of heat is further provided in which a thermally conductive plate according to the invention is used. In preferred embodiments of the invention an electrochemical energy store is temperature controlled, that is cooled or heated, by bringing its electrical contacts in thermally conducting contact with a thermally conductive plate according to the invention.

In the following, the invention is described in more detail with the help of preferred embodiments and with the help of these figures:

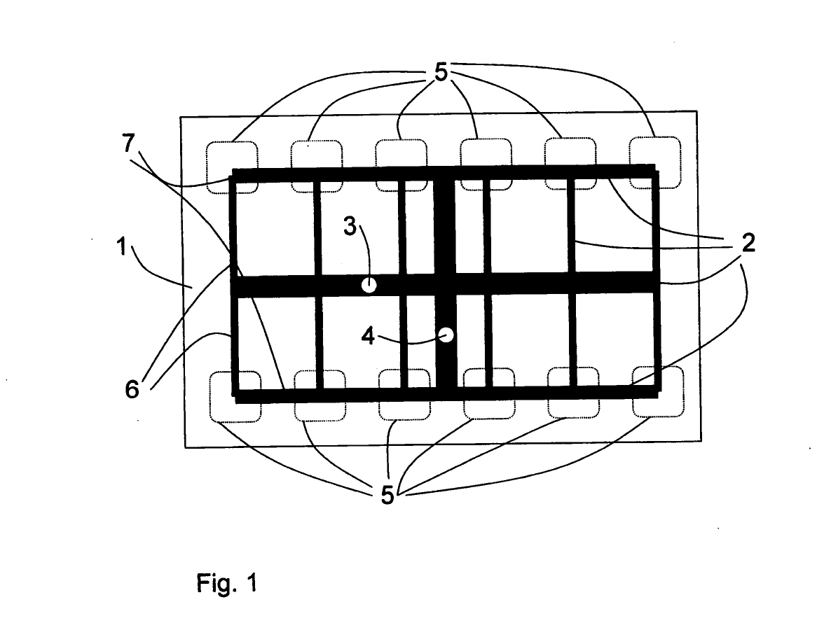

FIG. 1 shows schematically and in plan view a preferred example of a thermally conductive plate according to the invention;

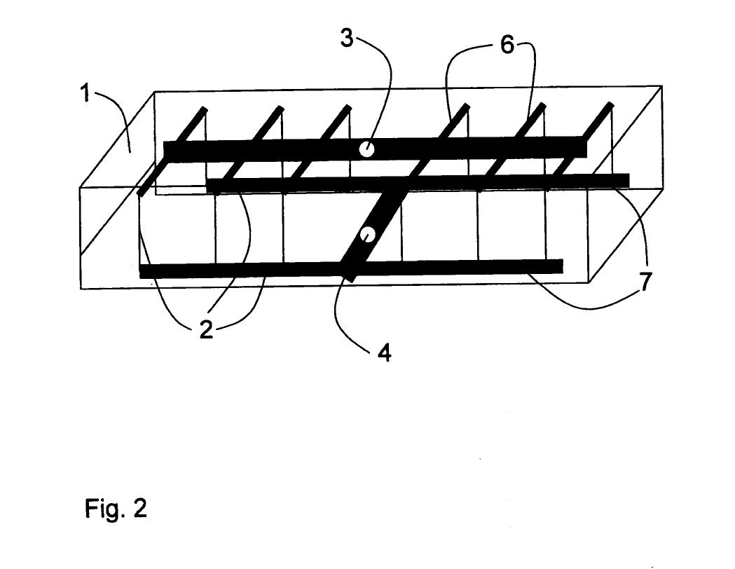

FIG. 2 shows schematically and in perspective view a preferred embodiment example of a thermally conductive plate according to the invention;

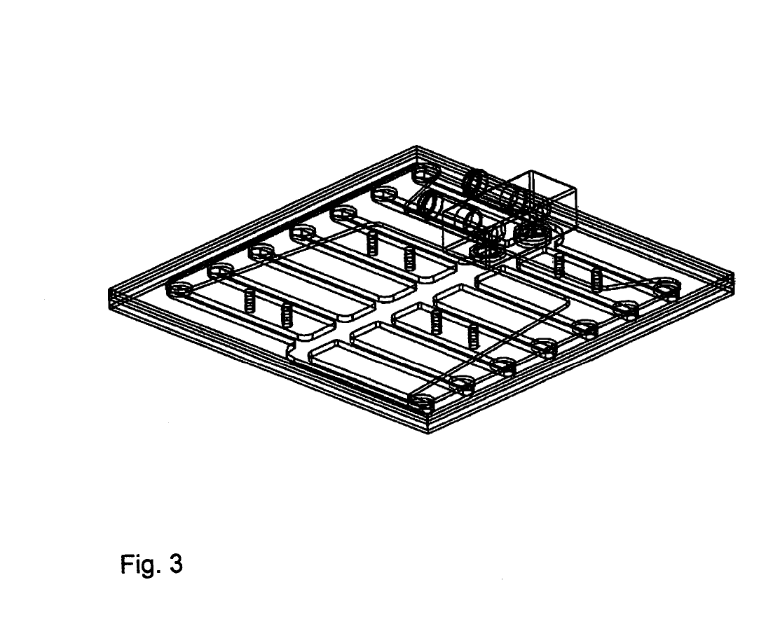

FIG. 3 shows schematically and in perspective view a preferred embodiment example of a thermally conductive plate according to the invention and

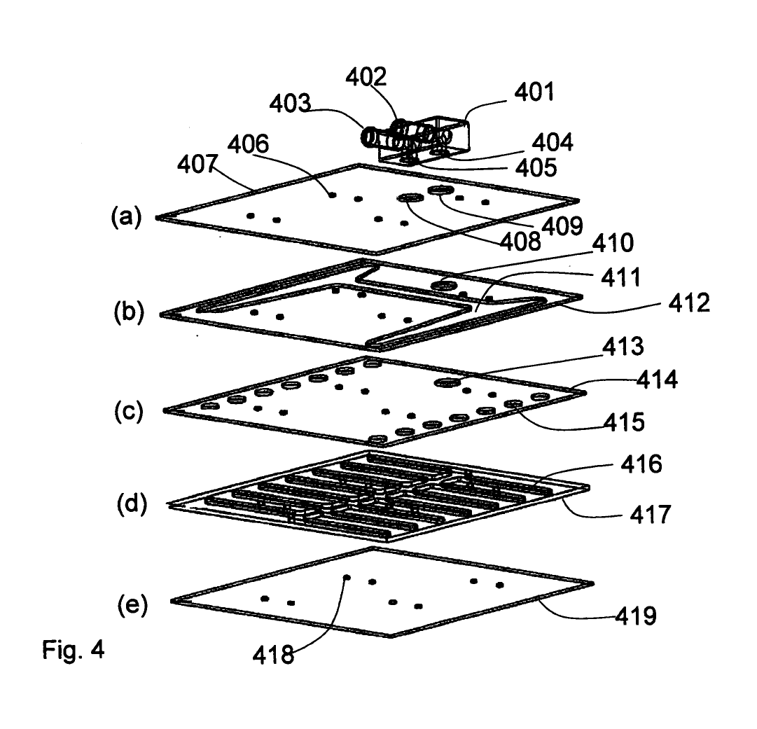

FIG. 4, consisting of FIGS. 4a to 4e, shows schematically an exploded view of a preferred embodiment example of a thermally conductive plate according to the invention.

As is shown in FIG. 1, the thermally conductive plate 1 is provided with a network of flow channels 2. A fluid flows through the inlet 3 into the distribution channels 6 and thus reaches the zones 5 to be temperature controlled, in which the fluid exchanges heat with its surroundings. Subsequently the fluid is collected in the collecting channels 7 and leaves the network of flow channels through the outlet 4.

FIG. 2 shows the same arrangement in a perspective view. The arrangement of distribution channels 6 in a higher level is recognisable, which channels 6 being connected via vertical running flow channels with the collecting channels 7 in a lower level. The depictions in FIGS. 1 and 2 are to be interpreted at least partially only schematically. In this way the distribution channels 6 and the collecting channels 7 can have other tree-like structures whose parts do not need to run straight, nor horizontal, nor vertical.

The invention is not limited to the shown embodiment examples and is based on the general concept of delivering a fluid via a tree-like structure of distributors to the zones 5 to be temperature controlled, of a thermally conductive plate, and collecting the fluid in such zones 5 to be temperature controlled with the help of a tree-like structure of collector channels 7. Thus the invention makes use of a principle known from human or animal blood circulation, wherein an artery increasingly branches off until the vessels transition into capillaries which the organism pumps uniformly or according to physiological requirements.

The embodiment examples described above and below can also advantageously be combined with one another.

The invention provides a thermally conductive plate 1 having a network of flow channels 2, at least one inlet 3 and at least one outlet 4 for a fluid. The flow channels 2 are arranged in the thermally conductive plate 1 such that a fluid, which flows into the network of flow channels 2 at the at least one inlet 3, flows through an arrangement of zones 5 of the thermally conductive plate 1 whose temperature is to be controlled, and can then flow out of the network of flow channels 2 at the at least one outlet 4.

The flow channels are arranged one above the other in at least two levels. The network of flow channels 2 comprises a tree-like structure of distribution channels 6, which is arranged on at least one first level, which distribution channels 6 guide a fluid to zones 5 of the thermally conductive plate whose temperature is to be controlled starting from the at least one inlet 3 into the network of flow channels 2. The network of flow channels 2 comprises a tree-like structure of collecting channels 7 which is arranged on at least one second level, which collecting channels 7 receive a fluid from the distribution channels in the zones 5 of the thermally conductive plate 1 whose temperature is to be controlled, and guide said fluid out of the network of flow channels 2 at the at least one outlet 4.

Moreover a method for the transport of heat, for example for cooling or heating of a car battery, is provided in which a thermally conductive plate 1 according to the invention is used. Finally an electrochemical energy store according to the invention is also provided, which is temperature controlled either with the help of a method according to the invention, or whose electrical contacts are at least partly in thermally conductive contact with at least one thermally conductive plate 1 according to the invention. In this context a thermally conductive plate 1 is understood to be a thermally conductive body which, due to its form or its material properties and preferably because of its constructive properties, is suited to transporting heat from at least one heat source to at least one heat sink.

The thermally conductive plate 1 according to the invention includes an arrangement of zones 5 to be temperature controlled, which are crossed by flow channels 2 such that the fluid flowing through the flow channels 2 flows through, over, and under these zones 5 to be temperature controlled. Said zones 5 to be temperature controlled can completely or partly cover the thermally conductive plate 1; in particular said arrangement of zones 5 to be temperature controlled can consist of a single zone to be temperature controlled, which zone completely or partly covers the thermally conductive plate 1. The zones 5 to be temperature controlled can be arranged in different ways on both sides of the thermally conductive plate 1.

The flow channels are arranged in the thermally conductive plate 1 in two levels one above the other. Said levels lie, as shown schematically in the figures, preferably essentially parallel to both of the essentially parallel large external boundary surfaces of the essentially plate-shaped thermally conductive plate 1.

The network of flow channels 2 shown in FIGS. 1 and 2 includes essentially a first tree-like structure of distribution channels 6, which channels guide a fluid to the zones 5, of the thermally conductive plate 1 whose temperature is to be controlled, starting from an inlet 3 into the network of flow channels 2. A thermally conductive plate 1 according to the invention can contain a plurality of preferably tree-like fluid channel networks, through which different fluids with different physical properties, in particular thermal transport properties, can flow.

The fluid flowing through the flow channels 2 can also preferably change its physical state, in particular to transition from the fluid to gas phase, that is evaporate, and in doing so remove heat from its surroundings, or vice versa, that is change from the gaseous to the liquid phase, that is condense, and in this way deliver heat to its surroundings. Said phase changes can preferably take place in different areas of the network of flow channels 2 at the same time. For example the fluid can evaporate in the distribution channels 6 and condense in the collecting channels 7 or, vice versa, condense in the distribution channels 6 and evaporate in the collecting channels 7, according to which zones 5 are to be cooled or heated. With other embodiments, evaporation can take place in one part of the zones 5, while condensation takes place in another part of the zones 5.

The tree-like structure of distribution channels 6 shown in FIGS. 1 and 2 are designed so that it distributes the fluid, which enters the network of flow channels 2 at the at least one inlet 3, into the network of flow channels 2 in the way desired by the user so that fluid flows evenly or as a function of the strength of the heat source or sink, through, over and under the individual zones 5 to be temperature controlled.

As shown in FIGS. 1 and 2, the tree-like structures are connected in at least two levels with the advantage that the flow channels 2 can proceed very flexibly according to the particular requirements of the underlying application, whereas in the case of an arrangement in only one level, limitations would result due to the impossibility of flow channels 2 crossing each other.

Thermal contact surfaces, not shown in the figures, are preferably provided on some of the zones 5 to be temperature controlled on at least one side of the thermally conductive plate 1, which, due to its form, arrangement or material properties, is directed to establish a thermally conductive contact of the thermally conductive plate 1

with a heat sink or with a heat source. In this way thermal contact surfaces can preferably be suitably formed surfaces, in particular polished surfaces, which are not shown in the figures, on the inside or outside of one of the two essentially parallel external wall surfaces of the thermally conductive plate. Said surfaces are so formed and arranged that they assist in a thermally conductive contact of the thermally conductive plate 1 with corresponding surfaces of the heat sink or heat source.

FIG. 3 schematically shows a preferred embodiment example of a thermally conductive plate 1 according to the invention, whose individual pieces in the exploded view of FIG. 4, consisting of the Sub-Figures 4a, 4b, 4c, 4d, and 4e are shown. Said thermally conductive plate 1 consists of the base plate 419, shown in FIG. 4e, and the plates arranged directly above said base plate 419, i.e. plates 417, 414 and 412, shown in the FIGS. 4b, 4c and 4d, whereby plate 417 is the channel plate, plate 414 is the layer transition plate, and plate 412 is the distribution plate. The thermally conductive plate 1 also consists of the top plate 407, shown in FIG. 4a, onto which the connection flange 401 is placed, together with the connection supports 402 and 403.

The fluid flows through the thermally conductive plate 1 in a network of flow channels with at least one inlet 408 and at least one outlet 409 for the fluid. The flow channels 411 and 416 are arranged in the thermally conductive plate 407, 412, 414, 417, and 419 such that a fluid which flows in at the at least one entry 408 in the network of flow channels flows through an arrangement of zones of the thermally conductive plate 1 whose temperature is to be controlled, and then can flow out of the network of flow channels at the at least one outlet 409. The flow channels 411 and 416, are arranged one above the other in at least two levels, 412 in FIGS. 4b and 417 in FIG. 4d. The network of flow channels includes a tree-like structure arranged in at least a first level of distribution channels 411, which distribution channels guide a fluid to the zones of the thermally conductive plate 1 whose temperature is to be controlled starting from the at least one inlet 409 into the network of flow channels. The network of flow channels comprises a tree-like structure of collecting channels 416 which is arranged on at least one second level, which collecting channels 416 receive a fluid from the distribution channels 411 in the zones of the thermally conductive plate 1 whose temperature is to be controlled and guide said fluid out of the network of flow channels to the at least one outlet 409.

Thus the fluid flows from the connection supports 403 of the connection flange 401 via the outlet 405 of the connection flange 401 through the inlet 408 of the top plate in the distribution channel 411 of the distribution plate. At the end of the distribution channel 411, the fluid enters the layer transition plate through the openings 415, from where it exits from the thermally conductive plate 1 through the openings 413, 410, and 409 via the outlet 404 of the connection flange 401 and through the connection supports 402. The individual sub-plates are preferably screwed to each other at the openings 406 and 418.

1. A thermally conductive plate comprising:
a network of flow channels;
at least one inlet; and
at least one outlet for a fluid,
wherein the network of flow channels are arranged to allow a fluid which flows into the network of flow channels at the at least one inlet to flow through an arrangement of zones of the thermally conductive plate whose temperature is controlled and to flow out of the network of flow channels at the at least one outlet (4),
the flow channels are arranged one above another in at least two levels,
the network of flow channels comprises a tree structure of distribution channels, the tree structure being arranged on at least one first level, the distribution channels guiding a fluid to the zones to be temperature controlled of the thermally conductive plate, starting from the at least one inlet into the network of flow channels, and
the network of flow channels comprises a tree structure of collecting channels, the tree structure being arranged on at least one second level, the collecting channels receiving a fluid from the distribution channels in the zones of the thermally conductive plate whose temperature is to be controlled and guiding said fluid out of the network of flow channels at the at least one outlet.

2. The thermally conductive plate according to claim 1, wherein thermal contact surfaces are provided in at least some of the zones whose temperature is to be controlled, on at least one side of the thermally conductive plate, the thermal contact surfaces having a form or material properties configured to establish a thermally conductive contact between the thermally conductive plate and a heat sink or a heat source.

3. The thermally conductive plate according to claim 2, wherein the thermal contact surfaces belong to one of at least two groups of thermal contact surfaces, said thermal contact surfaces being electrically isolated from each other and from at least one portion the thermally conductive plate, the thermal contact surfaces being in thermally conductive contact with at least another portion of the thermally conductive plate.

4. The thermally conductive plate according to claim 3, wherein the thermal contact surfaces within each group are electrically connected to one another.

5. The thermally conductive plate according to claim 2, wherein at least one thermal contact surface remains in thermally conductive contact with a heat sink or with a heat source via an electrically insulating thermally conductive film or electrically insulating thermally conductive paste, said film or paste being arranged between the at least one thermal contact surface and a heat sink or heat source.

6. Thermally conductive plate according to claim 2, wherein structures are provided to mount fasteners to press at least one thermal contact surface against a heat sink or a heat source.

7. Thermally conductive plate according to claim 1, wherein the flow channels include an electrically insulating yet thermally conductive material.

8. A method for the transfer of heat, wherein a thermally conductive plate is used according to claim 1.

9. The method according to claim 8, wherein an electrochemical energy store is temperature controlled by electrical contacts thereof being brought into contact with a thermally conductive plate according to claim 1.

10. An electrochemical energy store which is temperature collected by a method according to claim 9.

11. An electrochemical energy store having electrical contacts, wherein at least some of said electrical contacts make thermally conductive contact with at least one thermally conductive plate according to claim 1.

12. An electrochemical energy store according to claim 11 including a plurality of electrochemical cells, wherein the electrical contacts of said electrochemical energy store are connected via electrically conductive structures of at least one thermally conductive plate in such a way that the electrochemical cells (10) are connected in at least one of series and parallel.
